(19) United States
(12) Patent Application Publication
(10) Pub. No.: US 2025/0001685 A1
(43) Pub. Date: Jan. 2, 2025

(54) POWDER BED FUSION ADDITIVE PRINTER BUILD PLATFORM DRIVE MECHANISM

(71) Applicant: RTX Corporation, Farmington, CT (US)

(72) Inventors: Lawrence Binek, Glastonbury, CT (US); Jesse Boyer, Middletown, CT (US)

(21) Appl. No.: 18/758,500

(22) Filed: Jun. 28, 2024

Related U.S. Application Data
(60) Provisional application No. 63/511,474, filed on Jun. 30, 2023.
(60) Provisional application No. 63/511,479, filed on Jun. 30, 2023.
(60) Provisional application No. 63/511,482, filed on Jun. 30, 2023.
(60) Provisional application No. 63/511,486, filed on Jun. 30, 2023.
(60) Provisional application No. 63/518,741, filed on Aug. 10, 2023.

(51) Int. Cl. B29C 64/241; B22F 10/28; B22F 12/00; B22F 12/37; B29C 64/153; B29C 64/232; B29C 64/245; B33Y 10/00; B33Y 30/00

(52) U.S. Cl. CPC B29C 64/241; B22F 10/28; B22F 12/226; B22F 12/37; B29C 64/153; B29C 64/232; B29C 64/245; B33Y 10/00; B33Y 30/00

(57) ABSTRACT

A build piston for a powder bed fusion (PBF) additive manufacturing system is an annular build platform that includes a drive shaft, bearing sleeve, and drive shaft actuation mechanism. The end of the drive shaft is attached to the bottom center of the build platform and moves the build platform in concert with the drive shaft. The bearing sleeve ensures linear alignment of the drive shaft. The drive shaft actuation mechanism rotates the drive shaft at a continuous rate that is coupled to the drive shaft's rate of translation up and down, moving the build platform in a helical pattern.

### CROSS-REFERENCE TO RELATED APPLICATION(S)

This application claims the benefit of U.S. Provisional Application 63/511,474 filed Jun. 30, 2023 for “POWDER BED FUSION ADDITIVE PRINTER ARCHITECTURE FOR ANNULAR GEOMETRIES;” U.S. Provisional Application 63/511,479 filed Jun. 30, 2023 for “POWDER BED FUSION ADDITIVE PRINTER BUILD HEAD;” U.S. Provisional Application 63/511,482 filed Jun. 30, 2024 for “, POWDER BED FUSION ADDITIVE PRINTER WITH INTEGRATED INSPECTION;” U.S. Provisional Application 63/511,486 filed Jun. 30, 2023 for “POWDER BED FUSION ADDITIVE PRINTER FOR PARTS WITH HELICAL SLICES;” U.S. Provisional Application 63/518,741 filed Aug. 10, 2023 for “POWDER BED FUSION ADDITIVE PRINTER BUILD PLATFORM DRIVE MECHANISM,” the disclosures of which are hereby incorporated by reference in their entireties. This application is also related to U.S. Attorney Docket No. 180880US01-U373-P15681US1 filed on even date herewith for “POWDER BED FUSION ADDITIVE PRINTER RECOATER FOR UNIFORM POWDER PACKING;” U.S. Attorney Docket No. 180881US01-U373-P15682US1 filed on even date herewith for “SHROUDED BUILD PLATE FOR POWDER BED FUSION ADDITIVE PRINTER,” and U.S. Attorney Docket No. 181028US01-U373-P15699US1 filed on even date herewith for “POWDER BED FUSION ADDITIVE PRINTER RECOATER FOR UNIFORM POWDER PACKING,” the disclosures of which are hereby incorporated by reference in their entireties.

### BACKGROUND

The present disclosure relates generally to powder bed fusion additive manufacturing and, more particularly, to a powder bed fusion additive manufacturing drive mechanism for annular geometries.

Powder bed fusion (PBF) additive manufacturing is an additive manufacturing, or 3-D printing, technology that uses a laser or other energy source such as an electron beam to sinter or fuse metallic or polymeric particles together in a layer-by-layer process. PBF is typically used as an industrial process to make near net shape parts. Some PBF processes sinter the build powder particles, while others melt and fuse the build powder particles. Laser Powder Bed fusion (PBF-LB) is also known as direct metal laser sintering (DMLS).

Build plates serve as a foundation upon which a PBF build (i.e., the “workpiece” or “part”) is built. Build plates for PBF additive manufacturing systems typically have a rectangular, square, or circular geometry, which provides the flexibility to support a wide variety of build shapes. As parts being made with PBF additive manufacturing processes get bigger, though, rectangular, square, or circular build plates present some disadvantages for builds having an annular shape. The disadvantages include the volume of unconsolidated (i.e., unused) powder that accumulates in the annulus of the annular-shaped build, the amount of time required to recoat the build plate with fresh build powder, and the amount of time required to raster the build head across the build plate. While it might be possible to reuse the unconsolidated powder for other purposes, reuse can be cumbersome. Accordingly, the relatively large amount of unconsolidated powder associated with annular-shaped builds, the time spent recoating the build plate, and the time spent rastering the build head over the build plate represent “waste” factors in the manufacturing process that would be preferable to avoid.

### SUMMARY

One aspect of this disclosure is directed to a build piston for a powder bed fusion (PBF) additive manufacturing system. The build piston is an annular build platform that includes a drive shaft, bearing sleeve, and drive shaft actuation mechanism. The end of the drive shaft is attached to the bottom center of the build platform and moves the build platform in concert with the drive shaft. The bearing sleeve ensures linear alignment of the drive shaft. The drive shaft actuation mechanism rotates the drive shaft at a continuous rate that is coupled to the drive shaft's rate of translation up and down, moving the build platform in a helical pattern.

Yet another aspect of this disclosure is directed to a method of making an annular part with a powder bed fusion (PBF) additive manufacturing system that includes installing in the PBF additive manufacturing system an annular build plate having an inner radius wall and an outer radius wall. The inner radius wall and the outer radius wall define a build area on the annular build plate between the inner radius wall and the outer radius wall. Build powder is delivered, with a powder delivery mechanism, to the build area to form a build powder bed while the build plate rotates. The build powder in the build powder bed is distributed, with a recoater, to provide even distribution of the build powder in the build powder bed while the build plate rotates. Energy is directed from an optical array positioned over the build area on the build plate to the build powder in the build powder bed to form a melt pool in the build powder bed while the build plate rotates. The Build powder from the melt pool is selectively sintered, using energy from the optical array, to form a layer of a consolidated part. The build plate is positioned on a build piston and the build piston is configured to rotate and vertically translate simultaneously and continuously. Throughout the method of making an annular part, the build piston's rate of rotation is coupled with the build piston's rate of vertical translation, causing the build plate to descend in a helical pattern and create a corresponding helical layer structure in the annular part. The energy directed from the optical array to the build powder is controlled to provide a selected energy density on the build powder based on the rate of rotation and rate of vertical translation of the build piston.

### BRIEF DESCRIPTION OF THE DRAWINGS

FIG. 1 is an illustration of one type of annular-shaped build that can be made with a powder bed fusion (PBF) additive manufacturing system.

FIG. 2 is an overhead schematic of a PBF additive manufacturing system having an annular-shaped build plate.

FIG. 3 is an elevation schematic of a PBF additive manufacturing system having an annular-shaped build plate.

FIG. 4 is an elevation schematic of a build piston of a PBF additive manufacturing system having an annular-shaped build.

FIG. 5 is an elevation schematic of the build piston of FIG. 4 showing a worm gear screw, bearing sleeve, and worm gear drive.

FIG. 6 is an elevation schematic of the build piston of FIG. 4 showing linear actuators to control the vertical translation and rotation of the drive shaft.

FIG. 7 is a schematic of a build head for use in a PBF additive manufacturing system having an annular-shaped build plate.

FIG. 8 is a schematic of an optical head array for use in a PBF additive manufacturing system having an annular-shaped build plate of the subject disclosure.

FIG. 9 is a graph showing a zone of preferred operating conditions for a PBF additive manufacturing system having an annular-shaped build plate.

FIG. 10 is a schematic of an integrated X-ray CT scanner for use in a PBF additive manufacturing system having an annular-shaped build plate.

FIG. 11 is a schematic representation of a part built using conventional, layer-by-layer PBF additive manufacturing process.

FIG. 12 is another schematic representation of a part built using conventional, layer-by-layer PBF additive manufacturing process.

FIG. 13 is a schematic representation of a part built using the disclosed, continuous helical layer PBF additive manufacturing process.

FIG. 14 is another schematic representation of a continuous helical layer formed with the disclosed PBF additive manufacturing process.

### DETAILED DESCRIPTION

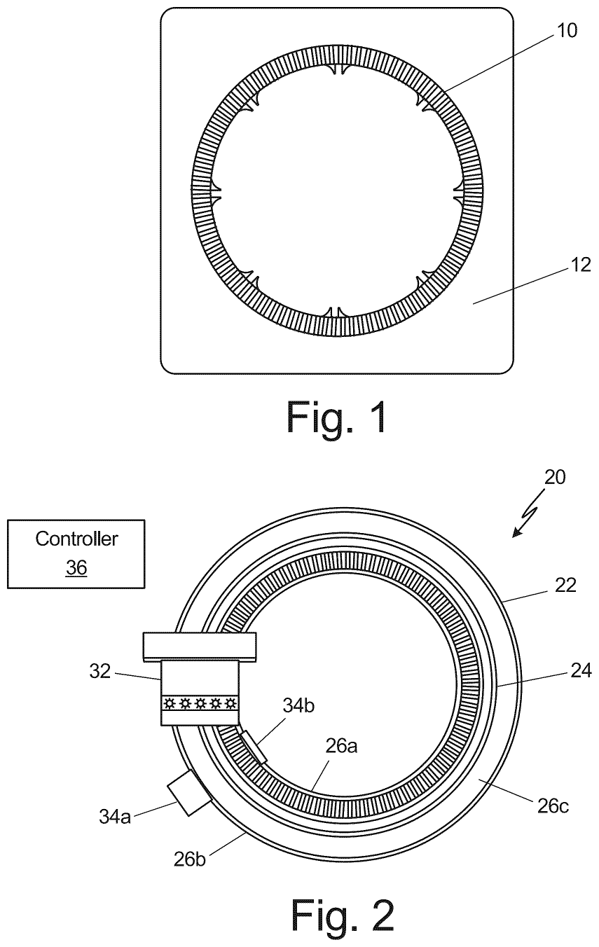

Powder bed fusion (PBF) additive manufacturing is an option to make near net shape parts with various geometries. Parts having an annular shape-particularly those with relatively large diameters can be a challenge. Examples of such annular-shaped parts include parts for gas turbine engines (e.g., compressor stages, turbine stages, combustor cans and combustion chambers, cases, etc.), other aerospace applications, and numerous commercial applications. FIG. 1 shows a non-limiting, exemplary gas turbine engine compressor stage 10 made using a PBF additive manufacturing process. Parts such as the gas turbine engine compressor stage 10 and other parts can be valuable for original equipment assemblies and for in-service sustainment requirements. Generally, annular-shaped parts, such as the gas turbine engine compressor stage 10, can be printed in their entirety in a large format PBF additive manufacturing machine. Because the part envelope of conventional large format machines is typically rectangular, square, or circle shaped with correspondingly shaped rectangular, square, or circular build plates 12, such machines are not ideal for annular-shaped parts because the annulus of annular-shaped parts results in a large area of unconsolidated build powder within the annular ring. Depending on the PBF additive manufacturing process used to make such parts, the large area of unconsolidated build powder can end up being “wasted,” which drives up the expense of making such parts with conventional PBF additive manufacturing methods. Accordingly, there is often not a business case to support using conventional PBF additive manufacturing methods for annular-shaped parts.

In addition to challenges with efficient use of build powder when using conventional PBF additive manufacturing methods for annular-shaped parts, the cycle time for large format conventional PBF additive manufacturing systems can be challenging. The architecture of conventional PBF additive manufacturing systems requires that the energy source (e.g., laser or electron beam) track the rectilinear cartesian coordinates of the part on the rectangular or square build plates. For annular-shaped parts, this means that the energy source in a conventional PBF additive manufacturing system spends significant time tracking over portions of the build powder bed that will not be consolidated to make the annular-shaped parts. As a result, a significant portion of the build time for such parts is non-productive in that the energy source is tracking over the build powder bed without consolidating any of the build powder. The large amount of non-productive build time is another type of “waste” that further drives up the expense of making such parts with conventional PBF additive manufacturing methods.

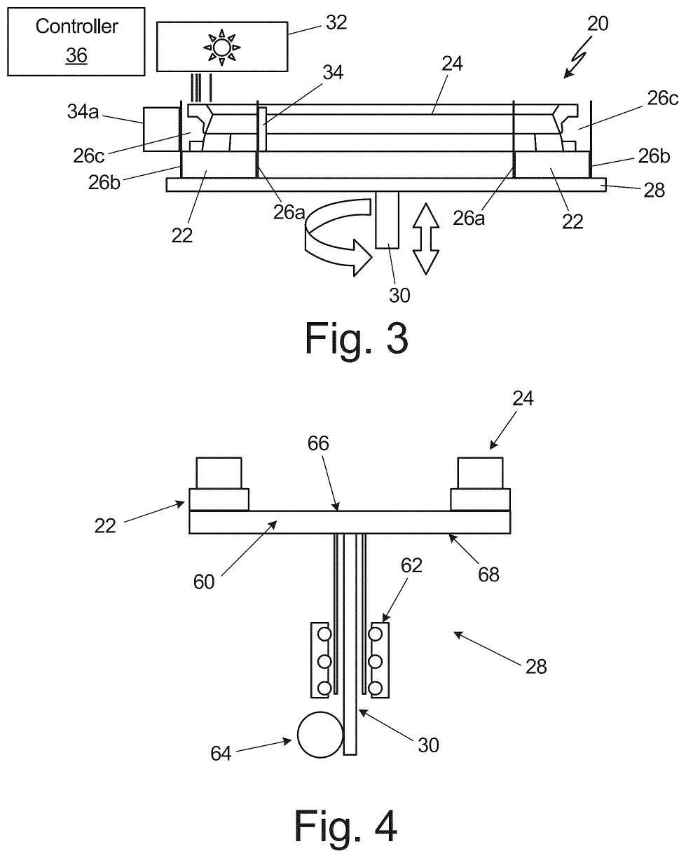

As shown in FIGS. 2 and 3, this application discloses a PBF additive manufacturing system 20 and a PBF additive manufacturing drive mechanism system that replaces the conventional rectangular or square build plate with a rotating annular build plate 22 for making annular-shaped parts 24. The rotating annular build plate 22 is surrounded by walls 26, including inner radius walls 26a and outer radius walls 26b, to define a build area 26c that contains a powder bed (not shown) of build powder during the PBF additive manufacturing process and positioned on a build piston 28. The build piston 28 is configured to rotate the build plate 22 in a continuous circular motion and to translate down as the PBF additive manufacturing process progresses to form part 24. The build plate 22 moves in concert with the build piston 28. The rotation and downward translation of the build piston 28 and build plate 22 allows for the part 24 to build up without stepping or interruption. As described in more detail below, the part 24 can be formed from a continuous, helical layer of consolidated build powder that overlays itself as the part 24 is built.

FIG. 4 is a more detailed schematic of the build piston 28 discussed above. The build piston 28 includes a build platform 60, a drive shaft 30, a bearing sleeve 62, and a drive shaft actuation mechanism 64. The build platform 60 includes a top portion 66 that engages with the build plate 22 and a bottom portion 68 that engages with the drive shaft 30. One end of the drive shaft 30 is attached to the build platform 60 at or near the bottom portion 68 of the build platform 60. The drive shaft 30 can be attached to the build platform 60 at or near the center of the bottom portion 68 of the build platform 60 to facilitate rotation of the build platform 60. The drive shaft 30 transmits drive forces from the drive shaft actuation mechanism 64 to the build platform 60 to cause the build platform 60 to rotate and translate vertically. The bearing sleeve 62 surrounds the drive shaft 30 and ensures linear alignment of the drive shaft 30. The bearing sleeve 62 may include any type of bearing suitable to ensure smooth rotation and linear alignment of the drive shaft 30, for example, ball bearings, roller bearings, and other types of bearings. The drive shaft actuation mechanism 64 is configured to rotate the drive shaft at a rate, which can be a continuous rate, that is coordinated with, and in some examples, coupled to the drive shaft 30 rate of vertical translation, to move the build platform 60 helically. The drive shaft 30 can also be configured to be removable from the build piston 28 so that a different configuration of drive shaft 30 can be used depending on a desired helical layer structure of the part 24 (see the discussion below) being produced by the PBF additive manufacturing system 20.

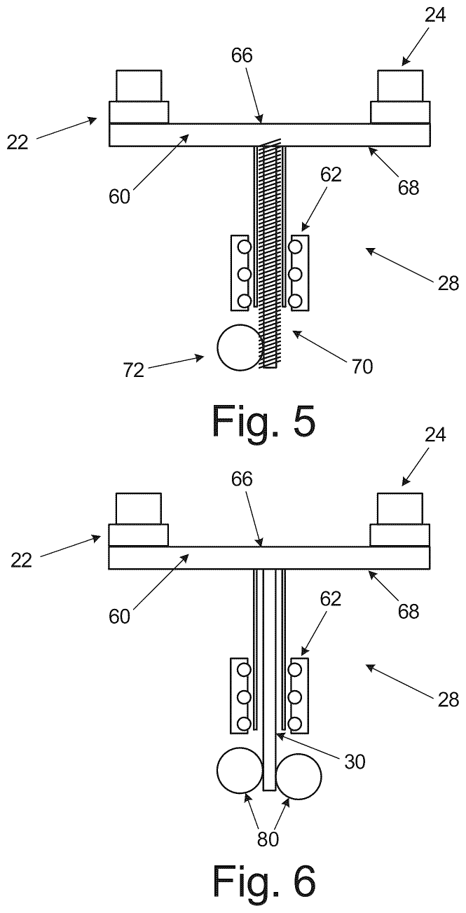

FIG. 5 is a schematic of another example of the build piston 28 of this disclosure, where the drive shaft 30 includes a worm gear screw 70 and the drive shaft actuation mechanism 64 includes a worm gear drive 72. As discussed above, the bearing sleeve 62 ensures smooth rotation and linear alignment of the worm gear screw 70. The worm gear screw 70 has a helically structured threading with a pitch, pitch angle, thread angle, and diameter that is appropriate to achieve a desired helical layer structure of the part 24 being produced by the PBF additive manufacturing system 20 (see the description below of the helical layer structure of the part 24). The worm gear screw 70 pitch, pitch angle, and thread angle, can be constant or variable across the length of the worm gear screw 70, depending on the desired helical layer structure of the part 24 being produced by the PBF additive manufacturing system 20. The worm gear drive 72 can be configured to rotate at a constant or variable speed in a clockwise or counterclockwise direction, depending on the desired helical layer structure of the part 24 being produced by the PBF additive manufacturing system 20. The worm gear drive 72 can be decoupled from the worm gear screw 70 and exchanged for a worm drive 72 with a different drive diameter and/or pattern of threading to alter the helical layer structure of the part 24 being produced by the PBF additive manufacturing system 20.

FIG. 6 is a schematic of another example of the build piston 28 of this disclosure, where the drive shaft actuation mechanism 64 includes linear actuators 80 configured to rotate the drive shaft 30 and translate the drive shaft 30 vertically. The rotation and vertical translation of the drive shaft 30 can be configured to be independent from each other or can be coupled to each other. The speed and direction at which the linear actuators 80 move the drive shaft 30 can be variable and is selected to generate a desired helical layer structure of the part 24 being produced by the PBF additive manufacturing system 20. In some examples, the linear actuators 80 can be configured to uncouple their rate of rotation and rate of vertical translation temporarily to achieve a desired helical layer structure of the part 24 being produced by the PBF additive manufacturing system 20. Additionally, the examples of FIGS. 5 and 6 can be combined such that an example includes a worm gear screw 70 as the drive shaft 30 and both a worm gear drive 72 and linear actuators 80 as the drive shaft actuation mechanism 64. In this example, either the worm gear drive 72 or the linear actuators 80 can engage to drive the drive shaft 30 at any given time so that both the worm gear drive 72 and the linear actuators 80 are not driving the drive shaft 30 at the same time. In this example, the worm gear drive 72 and the linear actuators 80 can both include the full range of features as discussed above.

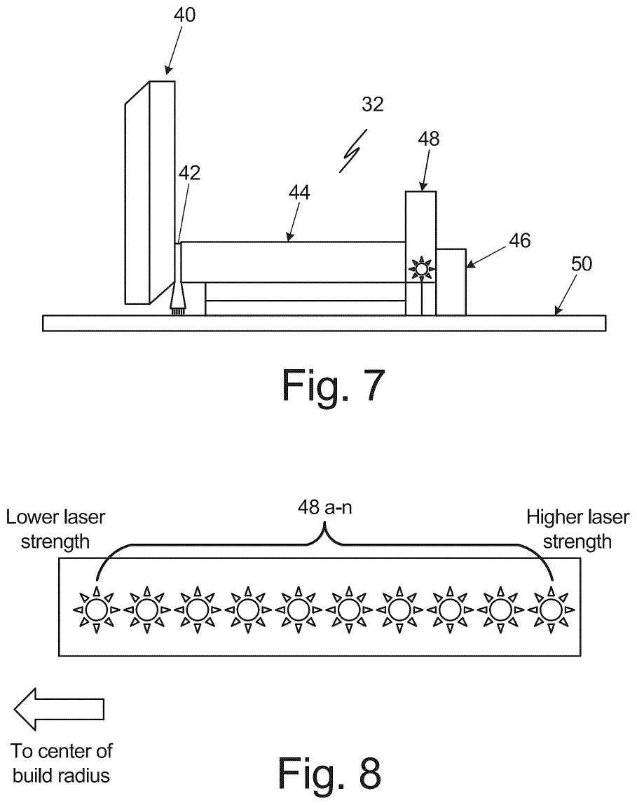

The PBF additive manufacturing system 20 can also include a multi-function build head 32 positioned at a predetermined height over the build area 26c that includes powder delivery mechanism, a recoater, a build powder preheater, a gas manifold, and an optical array as described in more detail below (see FIGS. 7 and 8). Alternately, each element of the multi-function build head 32 can be provided independently or as separate sub-assemblies. The multi-function build head 32 can be a static component that covers the operating radius of the build plate 22 (i.e., build area 26c, which is across the entire space between the walls 26 of the build plate 22) while the build plate 22 rotates and/or can be configured to translate vertically (i.e., up and down in the z-axis) to maintain a desired distance between the multi-function build head 32 and the top layer of the build powder bed in the build area 26c as the build campaign progresses. Additionally, the multi-function build head 32 can also be configured to translate radially across the build area 26c to provide complete coverage of the build area 26c. Regardless of configuration, the build head 32 covers the full build area 26c of the build plate 22 as the build plate 22 rotates and translates down as described above. Although only a single build head 32 is shown in FIGS. 2 and 3, any number of build heads 32 can be used in a particular PBF additive manufacturing system 20. For example, a PBF additive manufacturing system 20 consistent with this disclosure can include 2, 3, 4, or even more build heads 32 spaced at selected intervals. While each of the multiple build heads 32 may be spaced at regular intervals, the build heads may also be spaced at irregular intervals if such a spacing is deemed advantageous. Additionally, a PBF additive manufacturing system 20 consistent with this disclosure can be configured such that the number of build heads 32 can be changed between build campaigns. For example, a single build head 32 can be used for a first build campaign, 3 build heads 32 (or any other number of build heads 32) can be used for a subsequent second build campaign, and so on. The number of build heads 32 used for a particular build campaign can be determined based on the dimensions, complexity, build powder material, and other considerations for the part 24 to be built during the build campaign.

The PBF additive manufacturing system 20 can also include an x-ray computed tomography (CT or CAT) scan system 34, including scan head 34a and detector 34b, as described in more detail below (see FIG. 10) to integrate a continuous inspection process into the disclosed PBF additive manufacturing process. Although only a single CT scan system 34 is shown in FIGS. 2 and 3, any number of CT scan systems 34 can be used in a particular PBF additive manufacturing system 20.

As discussed further below, the PBF additive manufacturing system 20 also includes a controller 36.

FIG. 7 is a more detailed schematic of the multi-function build head 32 discussed above. The multi-function build head 32 provides a number of capabilities that enable the use of annular build plate 22 in a PBF additive manufacturing system 20. The build head 32 includes a powder dispensing mechanism 40, recoater 42, powder heating element 44, gas manifold 46, and optical array 48, which includes an energy source such as a laser or electron beam source. As discussed above, the build head 32 can remain stationary as the annular build plate 22 rotates, can be configured to translate vertically (i.e., up and down in the z-axis) to maintain a desired distance between the multi-function build head 32 and the build powder bed 50 as the build campaign progresses, and/or can be configured to translate radially across the build area 26c. Translating the build head 32 and the optical array 48 in the z-axis and/or radially across the build area 26c can contribute to repeatable consolidation of the part 24.

The powder dispensing mechanism 40 is configured to distribute additional build powder over the part 24 after each portion of the continuous, helical layer is formed on the part 24 in a manner similar to the distribution of build powder in conventional PBF additive manufacturing systems. The recoater 42 spreads the build powder distributed by the powder dispensing mechanism 40 evenly across the powder bed 50 so that each portion of the continuous, helical layer of the part 24 has a desired thickness. As discussed further below, due to the continuous rotation of the annular build plate 22 the continuous, helical layer of part 24 is deposited in a 2D plane having a pitch that reflects the build layer height. The powder heating element 44 heats unconsolidated build powder to facilitate complete, pore-free consolidation of the build powder. Each of the powder dispensing mechanism 40, recoater 42, and powder heating element 44 can be configured to operate similar to their counterparts in conventional PBF additive manufacturing systems.

The optical array 48 can include one or more energy sources (48a-n) to provide energy to form a melt pool (not shown) in the powder bed 50 that is selectively sintered and consolidated to form the continuous, helical layer of the part 24. The individual energy sources 48a-n can be lasers, such as laser diodes, electron beam sources, or other appropriate energy sources. For many applications, it may be desirable for the optical array 48 to include a plurality of energy sources 48a-n to provide coverage for the entire operative radius of the build plate 22 (i.e., across the entire space between the walls 26 of the build plate 22). As discussed further below, each of the plurality of energy sources 48a-n should be tuned with respect to the radial location of the individual energy sources 48a-n to maintain a consistent melt pool across the radius (i.e., the full build area 26c) of the annular build plate 22.

The gas manifold 46 blows an inert gas across the optical array 48 to diffuse the soot generated from the consolidated material. The inert gas may be nitrogen or any other inert gas suitable for the PBF additive manufacturing environment. The gas manifold 46 should be positioned to dispense inert gas to mitigate contamination to the optical array 48 and melt pool from soot or airborne build powder.

FIG. 8 shows a schematic of the optical array 48 in more detail, including individual energy sources 48a-n. Although, FIG. 8 shows ten individual energy sources, any number (“n”) of individual energy sources may be used-hence, this application uses the nomenclature 48a-n to represent the individual energy sources. The plurality of individual energy sources 48a-n is distributed radially over the build area 26c of the build plate 22 such that the individual energy sources 48a-n irradiate overlapping portions of the build area 26c. The individual energy sources 48a-n may be lasers, such as laser diodes, electron beam sources, or any other energy sources deemed appropriate for use in the PBF additive manufacture system 20. The rotating annular build plate 22 creates a demanding challenge for the optical array 48 due to the varying tangential velocity of the powder bed 50 across the radius of the build plate 22. As can be appreciated, when the annular build plate 22 rotates at a constant velocity the tangential velocity at the inner radius of the powder bed 50 is slower than at the outer radius of the powder bed 50. If the optical array 48 is configured to deliver constant power across the powder bed 50, the powder bed 50 will experience more effective energy at the inner radius than at the outer radius. This phenomenon could result in an inconsistent melt pool across the powder bed 50 radius, leading to inconsistent consolidation of the part 24 across the powder bed 50 radius. Accordingly, the power of the energy sources 48a-n in the optical array 48 should be scaled with respect to radial location to maintain constant effective energy density delivery across the radius of the powder bed 50. This means that the individual energy sources 48a-n in the optical array 48 will have differing power as a function of the location within the optical array 48. Thus, as shown in FIG. 8, individual energy sources closer to the center of the build radius (i.e., closer to the inner radius of the powder bed 50) should be configured to operate at a lower energy level than individual energy sources further from the center of the build radius (i.e., closer to the outer radius of the powder bed 50).

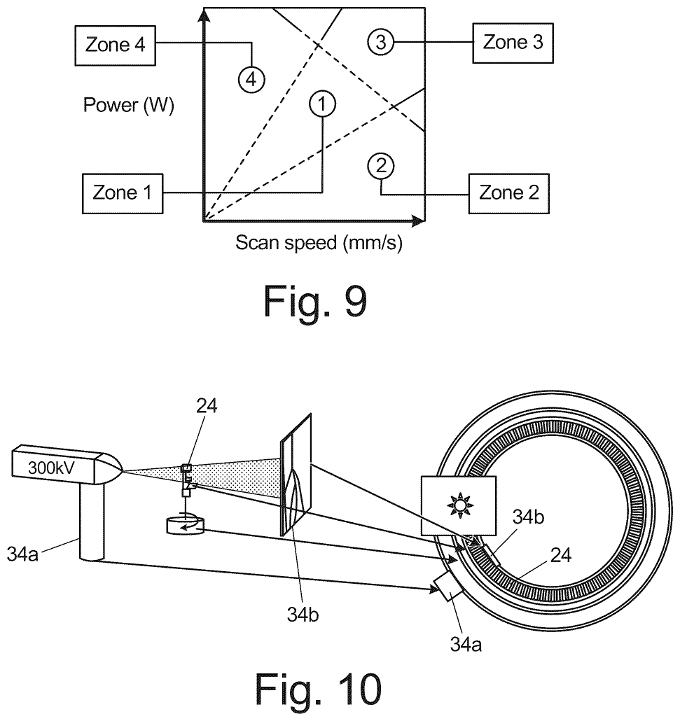

To accommodate the rotational speed of the annular build plate 22, the operating strength for each individual energy source 48a-n in the optical array 48 should be determined based on the rotational speed of the annular build plate 22 and the specific geometry of the part 24 to be built during a specific build campaign. FIG. 9. Shows a notional zone of desirable operating conditions for energy source power versus scan speed of a PBF additive manufacturing system 20 having an annular-shaped build plate 26. Because the multi-function build head 32 and the optical array 48 are generally stationary with regard to the rotating plane of the annular build plate 22, the energy source scan speed should be understood to be the tangential velocity of the build powder bed 50 at the radial location within the “view” of each individual energy source 48a-n in the optical array 48. FIG. 9 shows four zones of potential operation for the energy sources in the optical array 48:
Zone 1: the desired operating zone in which the energy source power is tuned to deliver a desired amount of energy based on scan speed (i.e., local tangential velocity) to melt and fuse the build powder to form fully consolidated layers (the “Just Right” zone)
Zone 2: a zone in which the energy source delivers insufficient energy too quickly in view of the scan speed (i.e., local tangential velocity) such that the local conditions are too cold for desirable melting and fusing of the build powder and layers (the “Too Cold” zone)
Zone 3: a zone in which the scan speed (i.e., local tangential velocity) is too fast to allow the build powder to absorb the energy source energy being delivered to the powder bed, leading to undesirable melting and fusing of the build powder and layers (the “Too Fast” zone)
Zone 4: a zone in which the energy source delivers too much energy in view of the scan speed (i.e., local tangential velocity) such that the local conditions are hot for desirable melting and fusing of the build powder and layers (the “Too Hot” zone)
   As can be appreciated, each energy source 48a-n in the optical array 48 should be tuned to operate within Zone 1 based on the parameters of each specific build campaign.

FIG. 10 is a schematic of an integrated X-ray computed tomography (CT or CAT) scan system 34, including an X-ray emitter or X-ray scan head 34a and an X-ray detector 34b, for use in a PBF additive manufacturing system 20 having an annular-shaped build plate 22. The X-ray scan head 34a includes an X-ray source of suitable power to penetrate the part 24 and side walls 26 of the build plate 22. For example, X-ray source may be 300 kV or any other power level deemed appropriate for the application. The X-ray detector 34b can be any suitable x-ray detector useful in an X-ray CT system that provides sufficient resolution to provide desired information about the part 24 as it progresses through the build campaign. The integrated X-ray CT system 34 works by having an X-ray scan head 34a located after the build head 32 (i.e., “downstream” of the build head 32 in the annular build plate's 22 direction of rotation) on the outer diameter of the annular build plate 22 with an X-ray detector 34b on the inner diameter with a linear path intersecting the part 24 such that the X-ray scan head 34a directs X-ray energy through the part 24 to the X-ray detector 34b. If the PBF additive manufacturing system 20 includes more than one build head 32, the PBF additive manufacturing system 20 can include a single X-ray CT system 34 positioned at an advantageous location with regard to the build plate 22 or may include more than one X-ray CT system 34. The X-ray detector 34b receives X-ray energy as it exits the part 24 to form an image of part 24 that can be examined manually or automatically for defects. The X-Ray CT system 34 can perform imaging of the part 24 in-situ during the build campaign as the annular build plate 22 rotates. If the X-Ray CT system 34 detects defects in the part 24 during the build campaign, the operator can be presented with various options to be implemented manually or automatically through controller 36. These options include varying the build campaign operating parameters as discussed below (e.g., power to individual energy sources 48a-n, rotational speed and/or height of the annular build plate 22, translation of the build head 32, operation of the powder dispensing mechanism 40, operation of the powder heating element 44, or any other operating parameters) to account for the identified defect(s) in the part 24 or, if the defect is serious enough, terminating the build campaign and manually reworking the part 24 or even scrapping the part 24.

The X-Ray CT scanning can also be decoupled from the build process if a final high-resolution scan needs to be taken once excess build powder has been evacuated from the part 24 but with the part 24 still affixed to the annular build plate 22. The post-build X-Ray CT scan could take place at a slower speed and/or higher resolution than might be convenient for the in-process scans discussed above and could form a portion of the final inspection of the part 24. Such an operation permits both in-process inspection of the part 24 during the build campaign and post-build inspection for part 24.

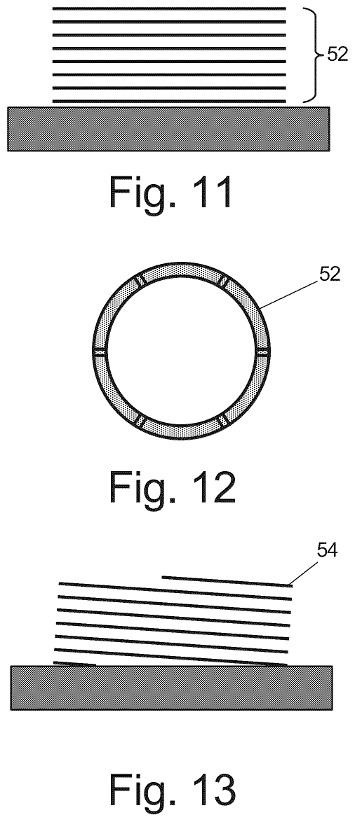

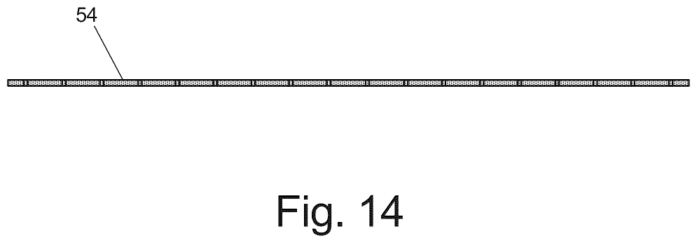

Using a rotating, annular build plate 22 as disclosed results in a unique layer structure in the part 24 compared with parts made with conventional PBF additive manufacturing processes. With a conventional PBF additive manufacturing system, parts have a “stacked” layer configuration as shown schematically in FIGS. 11 (“stacked” layers 52) and 13 (an overhead view of a single layer 52) in which a plurality of individual layers 52 are stacked and consolidated. Each of the plurality of individual layers 52 is oriented “parallel” with the build plate 22 on which the part 24 is formed. Using the disclosed PBF additive manufacturing system 20 with rotating, annular build plate 22 coupled with timed ascent or descent of the build head 32 or annular build plate 22, respectively, the part 24 has a continuous, single layer 54 that is “pitched” with respect to the build plate 22 on which the part 24 is formed. As shown schematically in FIG. 13, the continuous, single layer 54 is helically overlapped on itself across the entire thickness of the part 24 because of the continually rotating build plate 22. The pitch of the continuous, single layer 54 is determined by the height of the build powder layer used for a particular portion of the build campaign and the rotational speed of the rotating, annular build plate 22. If “unwrapped,” the single, helically-distributed layer 54 would form a continuous linear ribbon as shown in FIG. 14. Conceptualizing the single, helically-distributed layer 54 as a continuous linear ribbon can help define the tool path required for the optical array 48 to consolidate the build powder effectively. The curvature of the part 24 is handled by the rotation of the annular build plate 22 and is not part of the energy source scan consideration when determining appropriate power levels for individual energy sources 48a-n in the optical array 48. The single, helically-distributed layer 54 of part 24 should be detectible after consolidation as an artifact of the disclosed PBF additive manufacturing process.

Although not a focus of this disclosure, a person of ordinary skill will recognize that the disclosed PBF additive manufacturing system 20 relies on a controller 36 to control the rotation and height of the annular build plate 22 by rotating and translating the build piston 28, which in turn controls the local thickness and pitch of the continuous, helical layer that forms the part 24. Controller 36 also controls the operation of the build head 32, including the dispensing of build powder from powder dispensing mechanism 40 and the operation of the powder heating element 44, gas manifold 46, and optical array 48 as discussed above. For example, the controller 36 controls PBF system 20 operating parameters, including:
(1) energy source power, velocity, and spot size, build plate temperature, and layer thickness;
(2) temperature-dependent thermophysical properties of the powder;
(3) feedstock properties including average powder particle size; and
(4) energy source hatching strategy including hatch distance, hatch delay time, and stripe width.

The PBF system 20 can be used with a variety of build powders to produce part 24. For example, the powder can be a metal powder or polymeric powder. Metallic powders compatible with typical PBF systems 20 include aluminum, aluminum alloys (e.g., aluminum-lithium alloys), titanium, nickel, nickel alloys, and other metals and alloys known in the art. Polymeric powders compatible with typical PBF systems 20 include a wide variety of polymers as known in the art.

### Discussion of Possible Embodiments

The following are non-exclusive descriptions of possible embodiments of the present invention.

A build piston for a powder bed fusion (PBF) additive manufacturing system, wherein a build plate is an annular build plate comprising an inner radius wall; and an outer radius wall. The inner radius wall and the outer radius wall define a build area on the annular build plate between the inner radius wall and the outer radius wall. The annular build plate is configured to be positioned on the build piston and to move in concert with the build piston. The build piston is configured to rotate the build plate in a continuous circular motion and to translate down as the PBF additive manufacturing system progresses to form part. The build plate moves in concert with the build piston. The build piston consists of a build platform, a drive shaft, a bearing sleeve, and a drive shaft actuation mechanism. One end of the drive shaft is attached to the bottom center of the build platform and moves the build platform in concert with the drive shaft. The bearing sleeve ensures linear alignment of the drive shaft. The drive shaft actuation mechanism is configured to rotate the drive shaft at a continuous rate that is coupled to the drive shaft's rate of translation up and down, moving the build platform helically.

A powder bed fusion (PBF) additive manufacturing drive mechanism system comprises an annular build plate including an inner radius wall and an outer radius wall. The inner radius wall and the outer radius wall define a build area on the annular build plate between the inner radius wall and the outer radius wall. A build piston is configured to rotate around a drive shaft in a continuous circular motion and to translate up and down with respect to the annular build plate. The annular build plate is configured to be positioned on the build piston and to move in concert with the build piston. The build piston is configured to rotate the build plate in a continuous circular motion and to translate down as the PBF additive manufacturing process progresses to form part. The build plate moves in concert with the build piston. The build piston consists of a build platform, a drive shaft, a bearing sleeve, and a drive shaft actuation mechanism. One end of the drive shaft is attached to the bottom center of the build platform and moves the build platform in concert with the drive shaft. The bearing sleeve ensures linear alignment of the drive shaft. The drive shaft actuation mechanism is configured to rotate the drive shaft at a continuous rate that is coupled to the drive shaft's rate of translation up and down, moving the build platform helically.

The PBF additive manufacturing drive mechanism system of the preceding paragraph can optionally include, additionally and/or alternatively, any one or more of the following features, configurations and/or additional elements:

A further embodiment of the foregoing PBF additive manufacturing drive mechanism system, further comprising a build powder delivery mechanism configured to deliver build powder to the build area to form a build powder bed when the PBF additive manufacturing system is in operation, a recoater configured to provide even distribution of the build powder in the build powder bed when the PBF additive manufacturing system is in operation, and an optical array positioned over the build area on the build plate. The optical array is configured to project energy onto the build powder bed to form a melt pool in the build powder bed when the PBF additive manufacturing system is in operation.

A further embodiment of the foregoing PBF additive manufacturing drive mechanism system, wherein the drive shaft is configured to be able to be exchanged for a drive shaft of a different variation

A further embodiment of the foregoing PBF additive manufacturing drive mechanism system, wherein the drive shaft comprises a worm gear screw.

A further embodiment of the foregoing PBF additive manufacturing drive mechanism system, wherein the drive shaft actuation method comprises a worm gear drive.

A further embodiment of the foregoing PBF additive manufacturing drive mechanism system, wherein the drive shaft actuation mechanism comprises linear actuators configured to independently rotate the drive shaft and independently translate the drive shaft vertically at variable speeds in a clock wise or counterclockwise direction, depending on a desired helical layer structure of a part being produced by a PBF additive manufacturing process.

A further embodiment of the foregoing PBF additive manufacturing drive mechanism systems, wherein the drive shaft actuation mechanism comprises a worm gear drive configured to be decoupled from the drive shaft and linear actuators configured to engage the drive shaft when the worm gear drive is decoupled and begin independently rotating and vertically translating the drive shaft.

A further embodiment of any of the foregoing PBF additive manufacturing drive mechanism systems, wherein the worm gear screw comprises a helically structured threading with a pitch, pitch angle, thread angle, and diameter that is appropriate to achieve a desired helical layer structure of a part being produced by a PBF additive manufacturing system.

A further embodiment of any of the foregoing PBF additive manufacturing drive mechanism systems, wherein the worm gear screw's helically structured threading is configured to have a pitch, pitch angle, or thread angle that is variable along the length of the worm gear screw, with the variability being determined by a desired helical layer structure of a part being produced by a PBF additive manufacturing system.

A further embodiment of any of the foregoing PBF additive manufacturing drive mechanism systems, wherein the worm gear drive is configured to rotate at a variable speed in a clockwise or counterclockwise direction, depending on a desired helical layer structure of a part being produced by a PBF additive manufacturing system.

A further embodiment of any of the foregoing PBF additive manufacturing drive mechanism systems, wherein the worm gear drive is configured to have a variable thread pattern, with the variability being determined by a desired helical layer structure of a part being produced by a PBF additive manufacturing system.

A further embodiment of any of the foregoing PBF additive manufacturing drive mechanism systems, wherein the worm gear drive is configured to be decoupled from the drive shaft and swapped out for a worm gear drive of a different diameter and/or different pattern of threading.

A further embodiment of any of the foregoing PBF additive manufacturing drive mechanism systems, wherein the linear actuators are configured to temporarily uncouple their rate of rotation and rate of vertical translation to achieve a desired helical layer structure of a part being produced by a PBF additive manufacturing system.

A method of making an annular part with a powder bed fusion (PBF) additive manufacturing system, comprising installing in the PBF additive manufacturing system an annular build plate including an inner radius wall and an outer radius wall. The inner radius wall and the outer radius wall define a build area on the annular build plate between the inner radius wall and the outer radius wall. Build powder is delivered, with a powder delivery mechanism, to the build area to form a build powder bed. The build powder in the build powder bed is distributed, with a recoater, to provide even distribution of the build powder in the build powder bed. Energy is directed, from an optical array positioned over the build area on the build plate, to the build powder in the build powder bed to form a melt pool in the build powder bed. Build powder from the melt pool is selectively sintered, using energy from the optical array, to form a layer of a consolidated part. Continuously rotating the build plate at a rate that is coupled with the rate the build plate continuously and simultaneously descends throughout the method of making an annular part, causing the build plate to descend in a helical pattern and create a corresponding helical layer structure in the annular part. The energy directed from the optical array to the build powder is controlled to provide a selected energy density on the build powder based on the rate of rotation and vertical translation of the build piston.

The method for making an annular part of the preceding paragraph can optionally include, additionally and/or alternatively, any one or more of the following features, configurations and/or additional elements:

A further embodiment of the foregoing method, wherein the helical descent pattern of the build plate is generated by a worm gear screw connected to the build plate that is actuated by a worm gear drive and supported by a bearing sleeve.

A further embodiment of the foregoing method, wherein the helical descent pattern of the build plate is generated by a manual coupling of the build plate's rate of rotation and rate of descent when both are linearly actuated independently, supported by a bearing sleeve.

A further embodiment of any of the foregoing methods, wherein the helical descent pattern of the build plate is modified by varying the pitch, pitch angle, thread angle, and/or diameter of the worm gear screw.

A further embodiment of any of the foregoing methods, wherein the helical descent pattern of the build plate is modified by varying the worm gear drive's rate of rotation, threading, and/or diameter.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A build piston for a powder bed fusion (PBF) additive manufacturing system, comprising:
a build platform; and
a drive shaft; and
a bearing sleeve; and
a drive shaft actuation mechanism,
wherein an end of the drive shaft is configured to be attached to the bottom center of the build platform and move the build platform in concert with the drive shaft, wherein the bearing sleeve is configured to ensure linear alignment of the drive shaft; and
wherein the drive shaft actuation mechanism is configured to rotate the drive shaft at a continuous rate that is coupled to the drive shaft's rate of translation up and down, moving the build platform helically.

2. A powder bed fusion (PBF) additive manufacturing system, comprising:
the build piston of claim 1; and
an annular build plate including an inner radius wall and an outer radius wall, wherein the inner radius wall and the outer radius wall define a build area on the annular build plate between the inner radius wall and the outer radius wall;
wherein the annular build plate is configured to be positioned on the build piston and to move in concert with the build piston.

3. The PBF additive manufacturing system of claim 2, wherein the drive shaft comprises a worm gear screw.

4. The PBF additive manufacturing system of claim 2, wherein the drive shaft actuation mechanism comprises a worm gear drive.

5. The PBF additive manufacturing system of claim 2, wherein the drive shaft actuation mechanism comprises linear actuators configured to rotate the drive shaft and translate the drive shaft vertically, wherein rotation and vertical translation of the drive shaft are actuated independently.

6. The PBF additive manufacturing system of claim 2, wherein the drive shaft actuation mechanism comprises a worm gear drive configured to be decoupled from the drive shaft and linear actuators configured to engage the drive shaft when the worm gear drive is decoupled and begin independently rotating and vertically translating the drive shaft.

7. The PBF additive manufacturing system of claim 2, wherein the drive shaft is configured to be able to be exchanged for a drive shaft of a different configuration.

8. The PBF additive manufacturing system of claim 3, wherein the worm gear screw comprises a helically structured threading with a pitch, pitch angle, thread angle, and diameter that is selected to achieve a desired helical layer structure of a part being produced by a PBF additive manufacturing system.

9. The PBF additive manufacturing system of claim 8, wherein the helically structured threading is configured to have a pitch, pitch angle, and/or thread angle that is variable along the length of the worm gear screw to generate a desired helical layer structure of a part being produced by a PBF additive manufacturing system.

10. The PBF additive manufacturing system of claim 4, wherein the worm gear drive is configured to rotate at a variable speed in a clockwise or counterclockwise direction to generate a desired helical layer structure of a part being produced by a PBF additive manufacturing system.

11. The PBF additive manufacturing system of claim 4, wherein the worm gear drive is configured to have a variable thread pattern to generate a desired helical layer structure of a part being produced by a PBF additive manufacturing system.

12. The PBF additive manufacturing system of claim 4, wherein the worm gear drive is configured to be decoupled from the drive shaft and exchanged for a worm gear drive of a different diameter and/or different pattern of threading.

13. The PBF additive manufacturing system of claim 5, wherein the drive shaft is configured to uncouple its rate of rotation and rate of vertical translation temporarily when linear actuators are in use to generate a desired helical layer structure of a part being produced by a PBF additive manufacturing system.

14. The PBF additive manufacturing system of claim 6, wherein the drive shaft is configured to uncouple its rate of rotation and rate of vertical translation temporarily when linear actuators are in use to generate a desired helical layer structure of a part being produced by a PBF additive manufacturing system.

15. A method of making an annular part with a powder bed fusion (PBF) additive manufacturing system, comprising:
installing in the PBF additive manufacturing system an annular build plate positioned on a build piston, wherein the annular build plate includes an inner radius wall and an outer radius wall that define a build area on the annular build plate between the inner radius wall and the outer radius wall and wherein the annular build plate and the build piston are configured to rotate and translate vertically simultaneously and continuously;
delivering, with a powder delivery mechanism, build powder to the build area to form a build powder bed;
distributing, with a recoater, the build powder in the build powder bed to provide even distribution of the build powder in the build powder bed;
directing energy, from an optical array positioned over the build area on the build plate, to the build powder in the build powder bed to form a melt pool in the build powder bed;
selectively sintering, using energy from the optical array, build powder from the melt pool to form a layer of a consolidated part; and
continuously rotating the build plate at a selected rate that is coupled with a selected rate of vertical translation of the build plate to cause the build plate to descend in a helical pattern and to create a corresponding helical layer structure in the annular part;
wherein the energy directed from the optical array to the build powder is controlled to provide a selected energy density on the build powder based on the rate of rotation and vertical translation of the build piston.

16. The method of making an annular part of claim 15, further comprising:
generating the helical descent pattern of the build plate by a worm gear screw connected to the build plate that is actuated by a worm gear drive and supported by a bearing sleeve.

17. The method of making an annular part of claim 16, wherein the helical descent pattern of the build plate is modified by varying the pitch, pitch angle, thread angle, and/or diameter of the worm gear screw.

18. The method of making an annular part of claim 16, wherein the helical descent pattern of the build plate is modified by varying the worm gear drive's rate of rotation, threading, and/or diameter.

19. The method of making an annular part of claim 15,
the selected rate of rotation and selected rate of descent of the build plate is controlled by linear actuators.
